(19) United States
(12) Patent Application Publication
(10) Pub. No.: US 2023/0042831 A1
(43) Pub. Date: Feb. 9, 2023

(54) INTELLIGENT RODENT MANAGEMENT SYSTEM

(71) Applicant: AIOT ELEMENTS PRIVATE LIMITED, Ahmedabad (IN)

(72) Inventors: Nirja SHAH, Ahmedabad (IN); Nachiket SHAH, Ahmedabad (IN)

(21) Appl. No.: 17/793,928

(22) PCT Filed: Feb. 27, 2021
(86) PCT No.: PCT/IN2021/050191

§ 371 Date: Jul. 28, 2022

(30) Foreign Application Priority Data
Feb. 28, 2020 (IN) 202021008484

(51) Int. Cl. A01M 23/08; A01M 23/18; A01M 31/00; H04W 4/38

(52) U.S. Cl. CPC A01M 23/08; A01M 23/18; A01M 31/002; A01M 31/008; H04W 4/38

(57) ABSTRACT

The present invention relates to an intelligent rodent management system which provide efficient, reliable, and effective system which traps the rodents or animals and manages disposal process from a remote location. The intelligent rodent management system is water resistant, which can effectively catch water borne rodents as well. The bait is placed on top part of the main body and the bait station is closed with a bait cap, the smell of the bait lures the animals from the entrance of the main body. The animals enter through the main body of the device wherein the door is operated through spring loaded mechanism. The intelligent rodent management system of present invention provides a collecting, communicating and analyzing system for received information about entry of animals and the data is stored on a cloud server through electronics hardware which consist of a modem and a processor.

### CROSS REFERENCE TO RELATED APPLICATION(S)

The present application is the U.S. national stage of International Patent Application No., PCT/IN2021/050191 filed on, which claims the benefit of priority to Indian patent application No. 202021008484, filed on Feb. 28, 2020, the disclosures of which is are incorporated herein by reference in its entirety their entireties as a part of the present application.

### FIELD OF INVENTION

The present invention relates to the field of pest control management and monitoring system and more particularly, intelligent, electronic animal trapping system with wireless communication capability. Includes a unique method to trap animals, monitor the trapper from a remote location and dealing with the management of the trapped animals for the proper disposal and continuous trapping.

### BACKGROUND OF INVENTION

Rodents have long been considered deadly pests and are the chief villain in the spread of the Bubonic Plague. The Center for Disease Control does list nearly a dozen diseases directly linked to Rodents. A 2015 study by the American Housing Survey (AHS) found that eighteen percent of homes in Philadelphia showed evidence of rodents. Most urban areas battle such as Boston, New York City, and Washington, D.C., also demonstrated significant rodent infestations. Cities like New York have specific regulations for eradicating Rodents; multifamily residences and commercial businesses must use a specially trained and licensed Rodent catcher.

Certain rodents like rats have the ability to swim up sewer pipes into toilets. Rodents will infest any area that provides shelter and easy access to sources of food and water, including under sinks, near garbage, and inside walls or cabinets.

Thus it is very essential to catch the rodents and control their population in order to control the disease caused by them.

Rodents are also significant vectors of disease. The black rat, with the fleas that it carries, plays a primary role in spreading the bacterium Yersinia pestis responsible for bubonic plague, and carries the organisms responsible for typhus, Weil's disease, toxoplasmosis and trichinosis. A number of rodents carry hantaviruses, including the Puumala, Dobrava and Saaremaa viruses, which can infect humans.

Rodents also help to transmit diseases including babesiosis, cutaneous leishmaniasis, human granulocytic anaplasmosis, Lyme disease, Omsk hemorrhagic fever, Powassan virus, rickettsia pox, relapsing fever, Rocky Mountain spotted fever, and West Nile virus.

Rodents are a nuisance and endanger public health, human societies, therefore traditionally, often attempts are made to control them. This involves poisoning, trapping or killing, methods that are not always safe or effective.

More recently, integrated pest management attempts to improve control with a combination of interventions that include education, making and applying laws and regulations, modifying the habitat, changing farming practices, and biological control using pathogens or predators, as well as poisoning and trapping.

Several methods are used in order to trap animals. Animal traps have been used since several decades. The snap trap is one of the oldest types of traps for mouse and rodent control. It has a removable bait cup to place the lure in a well like area, forcing the rodent to commit to the trap. But this method has certain disadvantages. Trapping skill is required and inspection and trap placement has to be done. It also requires more time in trap placement and monitoring. Moreover, these traps cannot be placed at places where there are children around, as there is a possibility that they would tamper with the trap. Furthermore, once the snap trap is sprung, they are ineffective until they are reset. If the rodent gets trapped by its tail or foot, it can drag the trap away if they are not secured.

On the other hand, glue traps are non-toxic and provide quick results but even though these traps are easy to use, they generally are not effective. They are ineffective in locations with a lot of dust, dirt or water. Also, they are less useful in extreme hot or cold temperatures. Moreover, Glue boards are more efficient in capturing small size animals like mouse than capturing larger size rodents like rats. In severe rodent infestations they can help reduce the populations, although other types of rodent control mechanism will also be required to supplement the glue traps. Glue trap also has its disadvantages and is not an efficient way to trap mice and rodents. Glue traps should not be placed in a way where they are easily visible in a room or near children or pets otherwise there is a possibility of a pet or child getting stuck to the glue on the trap. Due to the prolonged manner in which the rodent is trapped on a glue board, some consider this type of trap inhumane. Various prior arts show advance trapping mechanism and devices made for trapping rodents such as Patent Application CN205624111, which discloses an open type electronic trap, comprising of a cage, a cage door, a cage door controller and a bait tray. The bait tray is placed on the base of the cage, and one side of the front, rear, left and right four cage doors passes through the movable shaft and the cage is connected, the cage door controller is installed on the movable shaft, and the cage door controller controls the opening and closing of the cage door. Major drawback with conventional traps are that they are often placed in different areas of the house or site and there is no easy way of knowing when the trap mechanism was successful other than by viewing them manually. As the technology advances, several new wireless mouse trapping devices have come up in the market. Like Patent Application US 2008/0204253 discloses system for monitoring the presence and activity of live objects such as rodents or other pests, comprising a base station and at least one remote station; each remote station comprising sensing means to detect the presence of a live object and to produce a signal representative thereof, and a transmitter responsive to said signal and adapted to transmit a signal accordingly to the base station. Similarly, an advanced remote notification electronic rodent trapping system and method is disclosed in U.S. Pat. No. 9,743,657 wherein having a plurality of rearming electronic rodent trapping devices configured to wirelessly communicate trap information to a base station that is in communication with a cloud server. US2019/0220632 discloses a wireless monitoring device configured to monitor for triggering of a pest or animal trap with which the device is associated. The wireless monitoring device includes a motion detection sensor configured to detect at least one of: movement of a pest or animal trap with which the wireless monitoring device is operatively interfaced; and movement of an organism trapped by such trap. The wireless monitoring device also includes a wireless transmitter configured to transmit a radio frequency (RF) signal including data pertaining to: the detected movement; and a unique identifier associated with the wireless monitoring device which also includes a processing element configured to instruct the wireless transmitter to transmit the RF signal in response to detection. The wireless monitoring device disclosed here is using motion detection sensors like IR or PIR sensors and these sensors are known to drain the device battery very quickly. Another disadvantage with this device is the accuracy of detecting exact number of animals caught within the trapper device as PIR or IR sensor may consider the movement of the animal into the device as multiple count of animals trapped. Thus the present invention resolves the said issue by using a magnetic sensor on the one way door entry and uses a unique way in simplified manner to provide an accurate count of trapped animals into the trapped device with longer battery life.

Hence there is a dire need to develop a trapping mechanism which has a capability to catch multiple animals of rodent family effectively to save time and effort, which can be easily used in difficult environment (water and temperature resistant), flexible (to provide space for keeping multiple trapped animals in a humane way) and which can be easily used by a novice person without prior training or skills using sophisticated but easy to use intelligent cloud based software which provides accuracy and highly efficient to pinpoint exact location of the device. There is also a need for efficient and easy to operate animal trapping system to catch multiple animals of rodent family with continuous monitoring for large scale pest operations and/or industrial operations. Moreover, the effective identification mechanism should not use motion detection sensors like IR or PIR sensors as these sensors drains the device battery very quickly. Also, the motion detection system with a single sensor is not accurate in detecting exact number of animals caught within the trapper because the animal movement cannot get the accurate count of animals trapped as once the animal moves inside the trapper the PIR or IR sensor may consider that as additional count.

### OBJECT OF THE PRESENT INVENTION

The main object of the present invention is to provide new, efficient, effective, reliable and intelligent rodent management system which not only traps the animal effectively but also monitor and controls the disposing process of the trapped animals from a remote location for a proper disposal and continuous trapping.

Another object of the present invention is to provide a smart solution for trapping and managing multiple animals such as, mice, rats, rodents, squirrels and water rodents at multiple locations/sites with accuracy.

Another object of the present invention is to make sure the animal like a rodent does not damage the entire trapper and thus the present invention has designed the key trapper parts of metallic structure, which cannot be chewed and/or damaged by the rodents.

Another object of the present invention is to make the entire device a water resistant thus making it effective in catching water borne rodents as well. To achieve this object the battery and electronics provided in the intelligent body 100 of the present invention is double protected and are ceiling mounted.

Another object of the present invention is to ensure the trapping of the rodent, the bait is placed in a unique bait station which is designed in such a way that the smell easily passes through the small ventilation type windows 13 to lure an animal and at the same time the bait is covered by metallic plate so that the bait station 4 cannot be chewed on by the rodents and/or animals. The bait is placed in this unique bait station in such a way that it is easily to replace and effectively maintained.

Yet another object of the intelligent rodent management system in accordance with the present invention is the ease of cleaning and hence ease of maintenance which further adds to reduction of the operating cost of the pest control operation.

Another object of the intelligent rodent management system in accordance with the present invention is that it has a detachable flexible storage box 200, which can be attached or detached to the intelligent body 100, and the size of the storage box 200 can be adjusted according to the requirements based on the type of the animal and number of animals to be trapped. The storage box 200 can easily store multiple animals as well.

Yet another object of the intelligent rodent management system in accordance with the present invention is the spring loaded doors (which closes against the gravity) the first entry door 5a, the second entry door 5b on the Intelligent body 100 of the present invention, allows one-way entry for the animals ensuring that there is no chance of escaping from the trapper device in accordance with the present invention. The spring loaded first entry door 5a and the second entry door 5b of the intelligent rodent management system in accordance with the present invention consist of sensors 8 attached on the back side of each doors which helps to send accurate count of animals trapped to a cloud server. The spring loaded first entry door and the second entry door of the intelligent rodent management system is also at an angle so animals of different weight can open and enter due to its simple lever mechanism with the help of unique hinge 11 and slant shaped first entry door 5a and second entry door 5b acting as beam that helps in the trapping of a smallest animal with very light weight as well.

Another object of the intelligent rodent management system in accordance with the present invention is its portability which is due to the long lasting battery of the electronic device 20 and its unique power saving feature design wherein the device automatically goes into sleep mode after sending the data to the cloud server at predefined intervals, thereby consuming minimal amount of power.

Another object of the present invention is to provide a reporting system for collecting, communicating and analyzing information receiving from various trapping device and accurately managing and communicating data in real time with the animal handler making the job of the animal handler easy. Reminders and escalation with in the system ensures the animal handler finishes the work with in configured timeframe.

Yet another object of the present invention is to provide a complete management tool by providing a mobile application and a web portal for better management of multiple locations/sites for the pest control services.

These and other objects of the invention will be appreciated by reference to the summary of the invention and to the detailed description of the preferred embodiment that follow, it being understood that not all objects are necessarily simultaneously attained by each aspect of the invention, and that not all objects are necessarily fulfilled by each claim of the application.

### SUMMARY OF PRESENT INVENTION

The present invention relates to an intelligent rodent management system that provides efficient, reliable, and effective system. The intelligent rodent management system is water resistant which can effectively catch water borne rodents as well. The bait is placed on the main body to lure the rodents. The rodents enter through the main body of the device wherein the first entry door 5a and the second entry door 5b is operated through spring-loaded mechanism. The intelligent rodent management system of present invention provides a collecting, communicating and analyzing system for receiving information on entry of animals and the data is stored in a cloud server. The present invention provides a reporting system for collecting, communicating and analyzing information receiving from various trapping device and accurately managing and communicating data in real time with the handler making the job of the handler easy by remotely managing several sites/locations. The present invention is a complete management tool by providing a mobile application and web portal for better management of multiple location/site operations for pest control services.

### BRIEF DESCRIPTION OF THE PRESENT INVENTION

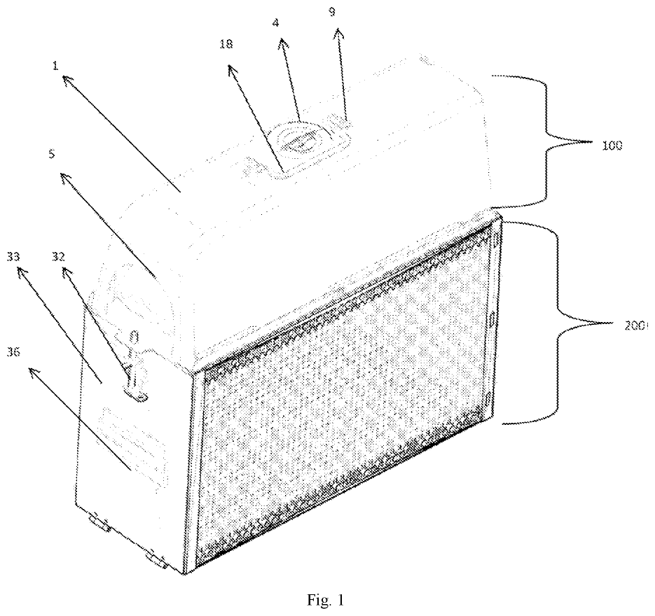

FIG. 1 represents a preferred embodiment of the present invention as inactive trapper.

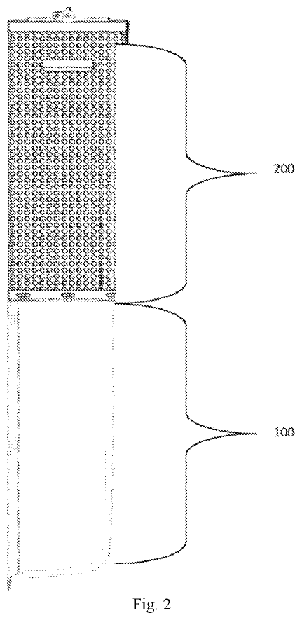

FIG. 2 shows the side view of a preferred embodiment of the present invention placed as activated trap.

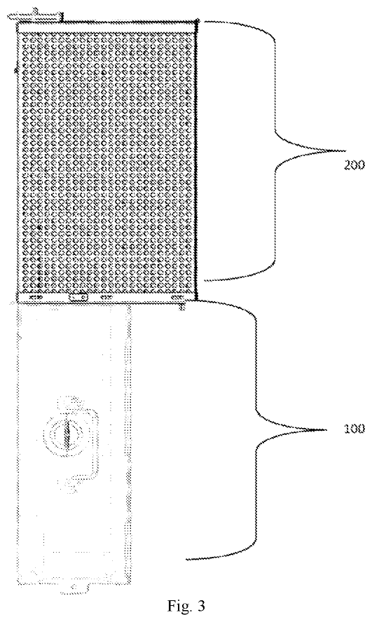

FIG. 3 shows the top view of a preferred embodiment of the present invention placed as activated trap.

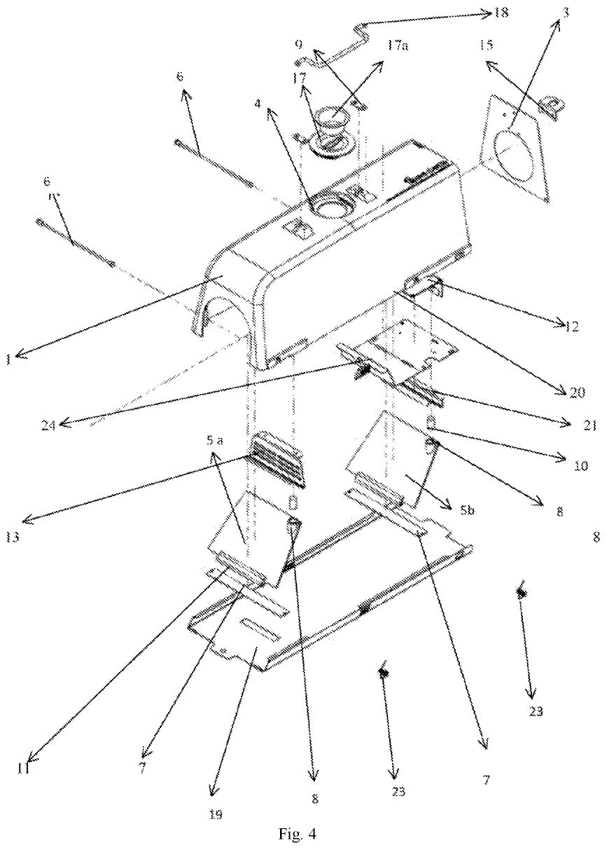

FIG. 4 shows the exploded view of the intelligent body 100 of the present invention.

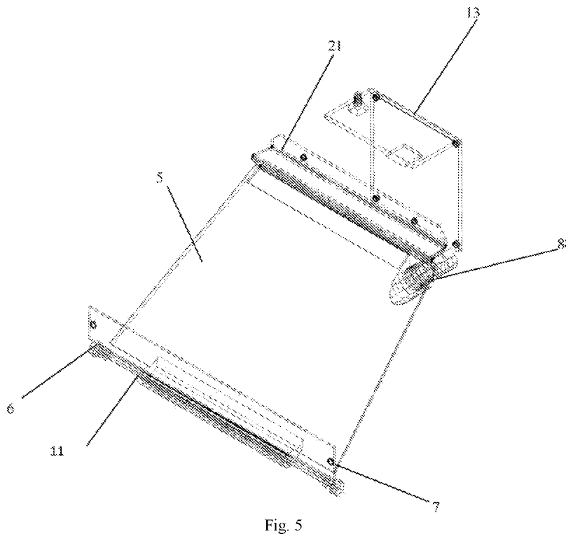

FIG. 5 shows the detailed perspective view of one of the spring-loaded entry door in the intelligent body 100 of the present invention.

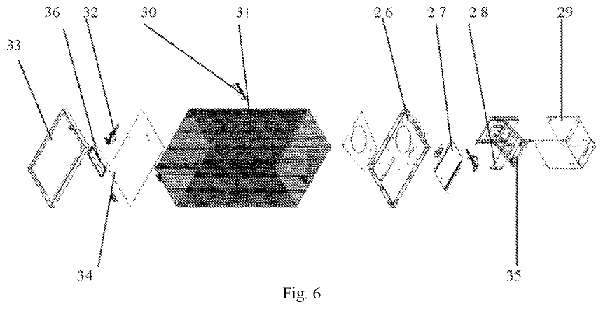

FIG. 6 shows the exploded view of the storage box 200 of the present invention.

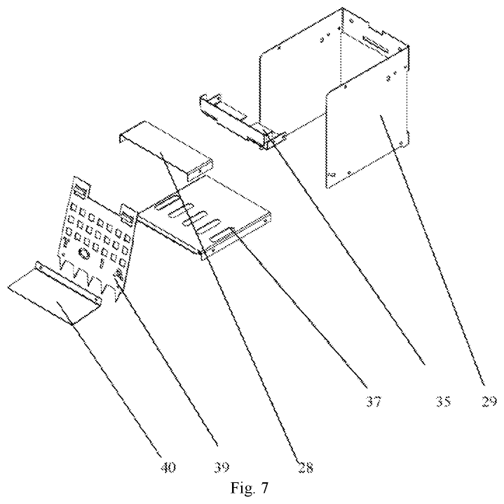

FIG. 7 shows in detail the entry door of the storage box 200 of the present invention.

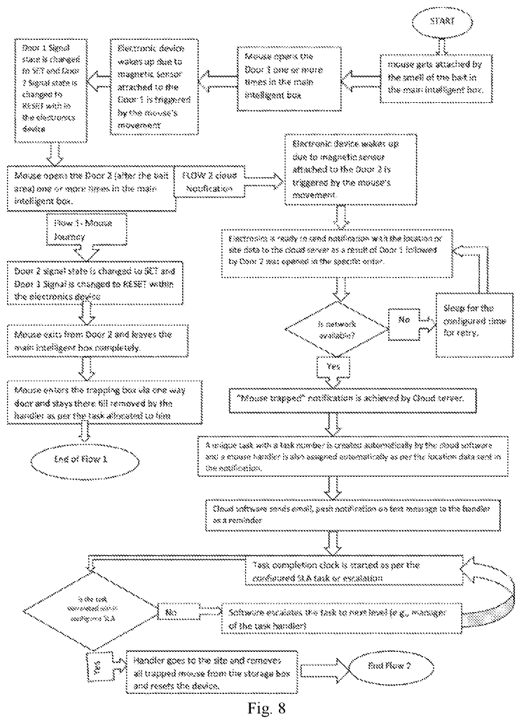

FIG. 8 illustrates a process flow chart for location of the trappers of the present invention on the site in accordance with the present invention.

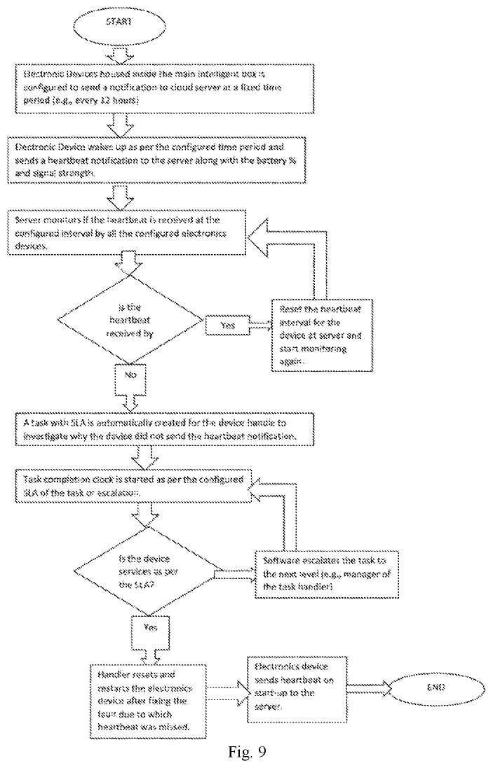

FIG. 9 illustrates a process flow chart for lost heart beat of the intelligent body 100 of the present invention when activated.

### DETAILED DESCRIPTION OF THE PRESENT INVENTION WITH REFERENCE TO THE DRAWINGS

The following paragraphs describe preferred embodiments of the device according to the present invention. The claimed subject matter is described with reference to the drawings, wherein like reference numerals are used to refer to like elements throughout. It will be obvious to a person of ordinary skill in the art will be aware that the activities described are only exemplary and several variations are possible, all of which are understood to fall within the scope of this disclosure. In other instances, well-known structures and devices are shown in block diagram form in order to facilitate describing the subject innovation. Moreover, the drawings may not be to scale. Accordingly, the specification and figures are to be regarded in an illustrative rather than a restrictive sense, and all such modifications are intended to be included within the scope of present invention. Any benefits, advantages, or solution to problems that are described herein with regard to specific embodiments are not intended to be construed as a critical, required or essential feature or element of any or all the claims.

The specification and drawings are accordingly, to be regarded in an illustrative rather than a restrictive sense. Thus, without analysis, the foregoing will so fully reveal the gist of the present invention that others can, by applying current knowledge, readily adapt it for various applications without omitting features that from the standpoint of prior art, fairly constitute essential characteristics of the generic or specific aspects of this invention.

The terms ANIMAL, MOUSE, RAT AND RODENT are used in same sense in the complete text of this document and may be taken as same for the purpose of disclosing the invention herein.

The terms SPRING LOADED DOORS, FIRST ENTRY DOOR, SECOND ENTRY DOORS, SLANT DOORS are used in same sense in the complete text of this document and may be taken as same for the purpose of disclosing the invention herein.

The terms STORAGE BOX, DUMB BOX, AND STORAGE DEVICE are used in same sense in the complete text of this document and may be taken as same for the purpose of disclosing the invention herein.

The terms TRAPPER DEVICE, AND TRAPPER are used in same sense in the complete text of this document and may be taken as same for the purpose of disclosing the invention herein.

In order to overcome the problems as recited in the background above and to fulfill the expectations of animal trapping mechanisms, the objective of the present invention is to provide a new, efficient, effective, reliable and intelligent rodent management system which not only traps the animal effectively but also monitor and manages proper disposal process from a remote location, which allows continuous trapping. The present invention provides a unique idea wherein the animal is guided through one chamber (intelligent body 100) and to the storage box 200 through one way opening entry doors 5 and aiding the animal to follow a particular path due to its behavioral habit and locking it into the storage box 200.

Intelligent Rodent Management System in accordance with the present invention consists of an intelligent body 100 and storage box 200 as shown in FIG. 1, which together is used as the trapping device to capture different types of animals. The trapping device shown in FIG. 1 is an inactive trapping device. FIG. 2, and FIG. 3 shows the side view and top view of the active trapping device in accordance with the present invention. FIG. 4 shows a detailed exploded view of the intelligent body 100. As shown in FIG. 4, the intelligent body 100 of the present invention comprises of a top portion, intermediate portion and bottom portion. The top portion of the intelligent body 100 comprises of a bait station 4 with a bait cap 17 and a bait cup 17a to accommodate bait inside the bait station 4. Said top portion having a handle 18 and handling strip 9 on the main body 1 is fixed with a screw. The intelligent body 100 of the present invention consists of Main body 1 that holds the bait station 4 on the top of the main body 1 wherein the bait is placed in the bait cup 17a to lure the animal into the trap. The bait is covered with a bait cap 17, which ensures the animal has to enter the intelligent body 100 for the bait and cannot reach or access the bait from the top of the intelligent body 100.

The intermediate portion of the intelligent body 100 comprises of an electronics compartment 20 which houses battery (NOT SHOWN IN THE FIGURE) with the capacity between 10,000 mAh to 14,000 mAh, and the open circuit voltage of battery between 3.5 v to 3.66 v and electronic device (NOT SHOWN IN THE FIGURE) with a communication modem and a processor to process information and communicate with a cloud server. A battery cover is fixed with a connector through a circuit plate nut (NOT SHOWN IN THE FIGURE) inside the main body's top portion with the electrical cover plate 24. The intelligent body 100 of the present invention also consists of electronics compartment 20 which holds the battery. Battery is the power source for the electronic hardware. The electronics compartment 20 holds one battery with capacity between 10,000 mAh to 14,000 mAh. The open circuit voltage of battery can be between 3.5 v to 3.66 v and recommended continuous current is 1800 mA with Pulse capability of 3500 mA. Battery Operating temperature −55° C.˜+80° C. The negative end of the battery is in contact with the spring and positive end of the battery is in contact with strip metal. Power is supplied by two wires from battery to the electronic hardware with colour code where red wire is for positive & black for negative.

The bottom portion of the intelligent body 100 comprises of a base plate 19 is a metal plate wherein the top portion of the intelligent body slides to accommodate the spring loaded mechanism fixed at a distal end of the multiple doors 5 by a fix plate 7, latch rod 6 and a hinge 11 allowing the movement of the first entry door 5a and second entry door 5b that allows the one-way entry for the animals into the intelligent body 100 of any size or weight. The animal will be able to open the entry doors 5 as they are fixed on a hinge 11 at an angle with latch rods 6 placed for each of the spring loaded doors 5 and if the animal is heavy they will open the door near the entry however if the animal is less in weight, the door will open once they climb up the slant door to open the entry door of the intelligent body. The Intelligent body 100 of the present invention consists of two entry doors, the first entry door 5a for the animal to enter the trap having a magnetic sensor 8 on the inside part of the main entrance door 5a and the second entry door 5b also consists of same magnetic sensor 8. The Front grill 13 and the rear door stop 21 at the top of the entry doors 5a and 5b is bent in such a way that it creates a stop for the animal to open the entry door from the inside or the other side of the entry door. The front grill 13 also allows the smell of the bait to travel through grills which lure the animal inside the intelligent body 100. The animal is attracted to the novel trapping device in accordance with the present invention, due to the attraction towards the smell of the bait from the bait station 4. The animal tries to open the first entry door 5a and is motivated from the intensifying smell of bait and is motivated to enter through one-way spring-loaded first entry door 5a and then eventually second entry door 5b. The back plate 3 of the intelligent body is connected with the connector 15 to the front plate 26 of the storage box 200 with connector making the movement of animal from intelligent body 100 to the storage box 200 in one direction without any hindrance or any possibility of animals escaping in between the intelligent body 100 and storage box 200. As shown in FIG. 6 the Storage box 200 that is attached to the intelligent body 100 comprises of a front plate 26, perforated metal box 31, gravity door unit as per FIG. 7, gravity door storage C plate 29, back exit door 33 and door latches 32, corner supports, gravity door hanger 35, latch stop lock, handle plate and handle rod 36.

As shown in FIG. 7 the gravity door unit consists of gravity door storage C plate 29, gravity door clamp 28, gravity door hanger 35, gravity door seat 37, gravity door 39 with spokes and an extension door attachment 40. Gravity door 39 with spokes and an extension door attachment 40 is welded together, which forms an L shaped door unit, which prevents animals from opening from inside of the storage box 200.

As represented in FIG. 8 and FIG. 9 the communication system of the intelligent body 100 consists of animal capture trigger circuit, device heart beat & reset trigger signal circuit. Once any trigger is generated in the present invention, communication system of the intelligent body 100 will start collecting data like signal strength, battery level, door status. The communication system of the intelligent body 100 will prepare a communication packet in a computer understandable format (like JSON) which contains readings of trigger mechanism, date & time along with the communication system of the intelligent body 100 unique number to send the collected data. The communication system of the intelligent body 100 has its own storage capacity to store and send data when required. The data generated is stored in the communication system of the intelligent body 100 and it is then sent to the cloud. The modem of communication system with-in intelligent body 100 initialises a connection with the cloud and upon successful connection, it sends data to a cloud server. The cloud server sends a response regarding the receipt of the data. In case when the connection is low or network connectivity is poor the data will be stored locally in the communication system with-in the intelligent body 100 storage and when the network connectivity is restored, the communication system of the intelligent body 100 will send stored data to a cloud server. Users can place request anytime to communication system for sending stored data via the cloud software. The power requirement to run the communication system of the intelligent body 100 is supplied by a battery. The intelligent rodent management system in accordance with the present invention has a unique feature of heartbeat monitoring of the internal device to optimize the battery life of the present invention wherein at configured monitoring intervals, device sends a message on server with signal and battery strength. Thus the communication system of the intelligent body 100 and software have an inbuilt feature of sleep mode for power saving of battery. The communication system of the intelligent body 100 wakes up once every 12 hours to send a heartbeat to the cloud (this interval is configurable), indicating that it is operational. The hardware and software immediately wake up once movement is detected on the spring loaded mechanism door 5a.

### A Preferred Embodiment and the Best Mode of Working of the Present Invention with Detailed Description

A preferred embodiment of the intelligent rodent management system in accordance with the present invention consists of an electronic device 20 attached to the trapping device with a storage box 200 wherein the electronic device 20 communicates wirelessly to a cloud server.

The intelligent rodent management system in accordance with the present invention provides a method, apparatus and a reporting system for collecting, communicating and analyzing information receiving from various trapping devices. The intelligent rodent management system in accordance with the present invention consists of an intelligent electronic device attached to a unique design storage box 200 for mouse, rats, other rodents and even animals like squirrels, and raccoons. The intelligent rodent management system in accordance with the present invention consists of an electronic device stored in compartment 20 (NOT SHOWN IN THE FIGURE) connected to a network via a SIM Card, which can transmit signals and send data to a cloud server and can be operated remotely. The intelligent rodent management system in accordance with the present invention consists of a complete management tool by providing a mobile application and web portal for better management of multiple location/site operations for pest control services. The intelligent rodent management system consists of steps and processes to be followed at the time of installation of the trapping device.

Installation process of trapper device in accordance with the present invention is as follows: The handler scans QR code on the intelligent rodent device and sets the priority of network (Wi-Fi, GSM, Wi-Fi+GSM). The handler sets the device by attaching the box and placing the bait in the bait station 4. Once the handler activates the device it is connected and configured into the management system in accordance with the present invention. Once the animal is trapped in accordance with the present invention the cloud software notifies the handler, that the handler needs to clear the trapped animal within predefined Service Level Agreement (number of hours to service the trapper) and is provided the site location. Thus an automatic task is generated for the handler by the management system in accordance with the present invention for removal of the trapped animal with a set due date and time. The system will communicate with the handler by way of notifications using multiple communication channels like SMS, email, in app notifications, etc. Once handler is on location/site, handler can identify using the mobile application where the trapper device is installed using a site map feature of the mobile application, this pin points the exact location of the trapper device. In case the handler does not clear the animal within the defined Service Level Agreement (number of hours to service the trapper), hander's supervisor is notified by an email and SMS so an alternative arrangements can be made.

One of the advantage of two-door mechanism first door entry 5a and the second door entry 5b is to prevent trapper mechanism to send incorrect animal counts to the cloud server. The accuracy is maintained even if a single animal opened and closed each door multiple times.

Once the cloud server picks up the data sent by the electronic device within the trapper, the cloud server software immediately processes the data and sends appropriate message/notification to the mobile device of the assigned animal hander by creating a task with a Service Level Agreement for the animal handler to service the trapper.

Table 1 shows the computation of the data received from the sensors 8 at door 5a and door 5b by the electronic device in electronics compartment 20.

TABLE 1

| Scenarios | Door-1 | Door-2 | Cloud Trigger |
|---|---|---|---|
| Scenario 1 | Opened | Not Opened | Not Triggered |
| | (one or | | |
| | more times) | | |
| Scenario 2 | Closed | Opened | Not Triggered |
| | | (one or | |
| | | more times) | |
| Scenario 3 | Closed | Closed | Not Triggered |
| Scenario 4 | Opened | Opened | Triggered and |
| | (one or | (one or | sent to cloud |
| | more times) | more times) | |

Thus table 1 concludes that the trigger will only be sent to a cloud server by the electronic device within electronics compartment 20 once both the doors are opened one or more times in a specific order (first entry Door 5a followed by second entry Door 5b). The intelligent rodent management system in accordance with the present invention counts the number of animals captured with a high accuracy. Animal due to the exploratory nature may open the door multiple times, however the electronic device just counts that signal as single. The electronic device collects data from the sensing element 8 at first entry door 5a when the animal passes through first entry door 5a. The electronic device inside electronics compartment 20 will be placed firmly with the handle onto the top portion of the intelligent body 100. Battery box is further placed with the help of the screw for the operation of intelligent body 100. A bait station 4 is placed next to the battery box to lure the animal. Once the animal (e.g. rodent) enters the one-way first entry door 5a completely, it will continue to look for a bait as the smell passes through the front grill 13 and realizes that it is trapped and can not go back from one-way first entry door 5a. As there are no other ways to move, it will continue to go through one-way spring loaded second entry door 5b to escape. Once the animal passes through the second entry door 5b, the sensing element 8 will send signal to the electronic device and because electronic device has already noted the signal of the first entry door 5a earlier, the electronic device will now send an animal capture trigger to the cloud as a confirmed trap. Once the animal passes through the second entry door 5b, it moves to the storage box 200 which is made of metallic structure box 31 and enters through the last entry door which is a gravity door 39 with spokes which fits into the seat 37. The storage box 200 is locked onto the back of the intelligent body 100 with the stopper and once the storage box 200 is filled the trapped animals can be removed from the back exit door 34 for ease of cleaning and removing the animals. The storage box 200 is a detachable box and thus can be replaced with another storage box for the ease of operation and continuous (24×7×365) trapping of the animals. For ease of movement with the entire trapping device, the storage box 200 can also be fixed below the intelligent body 100 as shown in FIG. 1 and can be carried easily by the handler when it is not activated. Once on the site the trapping device is activated and the storage box 200 is fixed on the back of the intelligent body 100 as shown in FIGS. 2 and 3. The storage box 200 also consists of an exit gate 33 from which the rodents are removed. The storage box 200 can be customized as to site-specific requirements and animal specific requirements. The storage box 200 is easily replaceable by the handler and is extremely easy to clean.

The software of the intelligent rodent management system in accordance with the present invention has several working modules as well. The intelligent rodent management system in accordance with the present invention has the ability to analyze the trapping sites and recommend a trapper movement based on historical number of rodents trapped between different trappers in different sites. The intelligent rodent management system in accordance with the present invention uses a unique algorithm to recommend the relocation of the trapper devices for example: When there is no rodents trapped on “Site 1” and many rodents trapped on “Site 2”, the software will automatically identify this and recommend that some trappers should be moved from “Site 1” to “Site 2”. The intelligent rodent management system in accordance with the present invention may consist of such several trapping devices shown in FIG. 1 at various sites and the uniqueness of the intelligent rodent management system in accordance with the present invention is that it will accurately manage and communicate data in real time with the handler making the job of the handler easy by remotely managing several sites.

The following description is of the best-contemplated mode of carrying out the invention. The description is made for the purpose of illustrating the general principles of the invention and should not be taken in a limiting sense.

We claim:

1. An intelligent rodent management system for trapping and managing multiple animals comprises of an electronic device configured with a trapping device consisting of:
an intelligent body 100, wherein the intelligent body 100 consists of a bait station 4 positioned on top section of the main body 1 of the intelligent body 100, wherein the bait station consists of a bait cup 17a in which the bait is placed and ventilation from the front grill 13 to lure the animal into the trapper device. The position of bait station 4 makes it easy to replace the bait. First one-way entry door 5a and second one-way entry door 5b attached to the base plate 19 with the help of a fix plate 7, latch rod 6 and a hinge 11 allowing the movement for the animals of different weights and sizes to enter the main body which accurately counts and reports number of animals entering the trapper;
an electronic compartment which houses battery with the capacity between 10,000 mAh to 14,000 mAh, and the open circuit voltage of battery between 3.5 v to 3.66 v and electronic device with a communication modem and a processor to process and communicate with a cloud server;
at least one magnetic sensor 8 embedded on each of the spring loaded doors 5 which once processed by the electronic device sends a trapping pulse to the cloud software;
a storage box 200 wherein the storage box consists of a front plate 26, metal wired box 31, one way gravity door 39 with spokes, gravity door storage C plate 29, gravity door clamp 28, gravity door hanger 35, gravity door seat 37, openable back door 33 for easy release of the trapped animals and a sliding mechanism 27 to close the one way door's 39 entrance hole 26 of the storage box 200 to ensure the trapped animal does not escape during transportation;
and a cloud software based on an algorithm that allows to monitor various trapper devices placed at multiple locations/sites which forms a network of trappers wherein the trapping device and its parts are connected with several connectors, screws and other holding parts.

2. The intelligent rodent management system as claimed in claim 1, wherein the intelligent 100 body has spring-loaded mechanism based first rodent entry door 5a and a second rodent entry door 5b that are closed at an angle with the help of springs 23 and hinges 11 to make sure the entry door will open and close regardless of the weight and size of the rodent/animal. The first entry door 5a locks with front grill's 13 unique bend and second entry door 5b locks with unique band of rear door stop 21, making both the doors one-way which can not be opened from the other side.

3. The intelligent rodent management system as claimed in claim 1, wherein the electronic compartment 20 also consists of a battery box for mounting the battery inside the battery box on the ceiling of the Main body 1 which makes the electronics parts water resistant.

4. The intelligent rodent management system as claimed in claim 1, wherein the storage box 200 consists of a locking mechanism that fixes the storage box 200 onto the intelligent body 100 so both do not get separated while trapping the animals. The detachable storage box 200 makes it possible to replace the storage box with another one, making 24×7×365 trapping possible.

5. The intelligent rodent management system as claimed in claim 1, wherein the modem and the processor consisting a communication system;
Wherein the communication system is triggered (awaken from deep sleep) by the magnetic sensors 8 sending electric pulse due to spring-loaded mechanism based first rodent entry door 5a movement;
Wherein the electronic device collects various data like signal strength, battery level, door status and prepares a communication packet which contains readings of trigger mechanism, date and sends the collected data to a cloud server using the modem;
Wherein the electronic device includes a local storage capacity to store data when modem is not able to connect with the cloud server;
Wherein the modem stores the data generated in a computer understandable format (as an example JSON format) and then sends animal trapped message to the cloud when a connection is re-established;
Wherein the cloud sends a response regarding the receipt of the data;
Wherein the electronic system wakes up as per configurable interval and sends a heartbeat data package using the modem, which informs the cloud server of the live connectivity;
Wherein the users from a cloud application can place a request to electronics device of any trapper for sending locally stored data to the cloud server, which will be available in the cloud application.

6. The intelligent rodent management system as claimed in claim 5, wherein the cloud software automatically creates a task for the animal handler once the electronics hardware sends animal trapped message to cloud server;
wherein the task created automatically also has a due date along with time to complete the task and reminders are sent using multiple communication channels;
Wherein if the task is not completed by the animal handler with-in the due data and time, multiple level of escalations are automatically created and notified by the software to the supervisors of the animal handler.

7. The intelligent rodent management system as claimed in claim 5, wherein upon completion of the task, the handler will be able to update the system about task completion using the mobile application connected to the cloud server.

8. The intelligent rodent management system as claimed in claim 1, wherein the cloud software does an analytics on the animals trapped by different trappers and based on current and historic data the cloud software may recommend moving the trapper from a lower (or no) animal trapping location to a higher animal trapping location to improve efficiency of all the trappers in the network.

9. The intelligent rodent management system as claimed in claim 1, the unique software algorithm embedded with-in the electronics hardware ensures multiple opening of the one-way doors 5 (5a and 5b) is not counted as multiple animals. The electronic device accurately counts the animal as trapped, when the animal opens first entry door 5a one or more times, followed by opening the second door 5b one or more times, in that specific order.
